(19) United States
(12) Patent Application Publication
(10) Pub. No.: US 2026/0303855 A1
(43) Pub. Date: Oct. 1, 2026

(54) MOTION INFORMATION PREDICTOR SELECTION

(71) Applicant: InterDigital CE Patent Holdings, SAS, Paris (FR)

(72) Inventors: Franck GALPIN, THORIGNE-FOUILLARD (FR); Antoine ROBERT, MEZIERES SUR COUESNON (FR); Philippe BORDES, LAILLE (FR); Fabrice LE LEANNEC, BETTON (FR)

(21) Appl. No.: 19/478,110

(22) PCT Filed: Apr. 18, 2024
(86) PCT No.: PCT/EP2024/060540

§ 371 Date: Oct. 23, 2025

(30) Foreign Application Priority Data
Apr. 27, 2023 (EP) 23315124.0

(51) Int. Cl. H04N 19/52; H04N 19/105; H04N 19/132; H04N 19/139; H04N 19/172; H04N 19/176; H04N 19/573

(52) U.S. Cl. CPC H04N 19/52; H04N 19/105; H04N 19/132; H04N 19/139; H04N 19/172; H04N 19/176; H04N 19/573

(57) ABSTRACT

A method comprising: obtaining an initial list of motion vector predictors candidates for a current block; obtaining bi-prediction candidates from the initial list, each bi-prediction candidate comprising two motion vectors, a first motion vector of the two motion vectors pointing on a first prediction block in a first reference picture and a second motion vector of the two motion vectors pointing on a second prediction block in a second reference picture; calculating a score for bi-prediction candidates of the initial list; and, obtaining a motion vector predictor for the motion information of the current block based on the calculated scores; wherein each score is value representative of a difference between a first template and a second template, the first template comprising samples of the first prediction block and the second template comprising samples of the second prediction block corresponding spatially to the samples of the first template.

### 1. CROSS REFERENCE TO RELATED APPLICATIONS

This application claims priority to European Application No. 23315124.0, filed Apr. 27, 2023, which is incorporated herein by reference in its entirety.

### 2. TECHNICAL FIELD

At least one of the present embodiments generally relates to a method and a device for picture encoding and decoding, and more particularly, to a method and a device allowing improving parallelization of operations in a decoding process.

### 3. BACKGROUND ART

To achieve high compression efficiency, video coding schemes usually employ predictions and transforms to leverage spatial and temporal redundancies in a video content. During an encoding, pictures of the video content are divided into blocks of pixels, these blocks being then partitioned into one or more sub-blocks, called original sub-blocks in the following. An intra or inter prediction is then applied to each sub-block to exploit intra or inter picture correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual block, is transformed, quantized and entropy coded to generate an encoded video stream. To reconstruct the video, the compressed data is decoded by inverse processes corresponding to the transform, quantization and entropic coding.

In recent video codec, new methods involving a template around a current block in order to infer or reduce the signaling cost had been developed. While in the past, decoding dependencies between successive blocks were avoided as much as possible to allow parallelizing the reconstruction of the blocks, templates introduced new decoding dependencies preventing the parallelization. These new dependencies put a heavy burden on decoding processes which cannot parallelize anymore most computationally intensive stages.

It is desirable to propose solutions allowing improving the parallelization in recent video codecs.

### 4. BRIEF SUMMARY

In a first aspect, one or more of the present embodiments provide a method comprising:
obtaining an initial list of motion vector predictors candidates for a motion information of a current block;
obtaining bi-prediction candidates from the initial list, each bi-prediction candidate comprising two motion vectors, a first motion vector of the two motion vectors pointing on a first prediction block in a first reference picture and a second motion vector of the two motion vectors pointing on a second prediction block in a second reference picture;
calculating a score for bi-prediction candidates of the initial list; and,
obtaining a motion vector predictor for the motion information of the current block based on the calculated scores;
wherein each score is value representative of a difference between a first template and a second template, the first template comprising samples of the first prediction block and the second template comprising samples of the second prediction block corresponding spatially to the samples of the first template.

In an embodiment, the method comprises re-ordering the bi-prediction candidates of the initial list based on the calculated scores to obtain a re-ordered list, the obtained motion vector predictor being obtained from the re-ordered list.

In an embodiment, the first template comprises all samples of the first prediction block and the second template comprises all samples of the second prediction block.

In an embodiment, the first template corresponds to bottom-right samples of the first prediction block and the second template corresponds to bottom-right samples of the second prediction block.

In an embodiment, the first template corresponds to top-left samples of the first prediction block and the second template corresponds to top-left samples of the second prediction block.

In an embodiment, each template is N pixels thick, N being a positive integer value.

In an embodiment, an integer-based motion compensation is applied to identify the first and the second templates respectively in the first and the second reference pictures.

In an embodiment, a motion vector difference is added to at least one bi-prediction candidates of the initial list before calculating the score.

In an embodiment, responsive to the initial list comprises uni-prediction candidates, only the bi-prediction candidates are re-ordered and each uni-prediction candidate keep a same index in the re-ordered list than in the initial list.

In an embodiment, responsive to the initial list comprises uni-prediction candidates, uni-prediction candidates of the initial list are transformed into a bi-prediction candidates before the calculation of the scores.

In an embodiment, bi-prediction candidates of the re-ordered list obtained from a uni-prediction candidate of the initial list are used for a prediction of the motion information of the current block.

In an embodiment, responsive to the initial list comprises uni-prediction candidates, uni-prediction candidates are excluded from the re-ordered list.

In a second aspect, one or more of the present embodiments provide a method for encoding a current block comprising the method of the first aspect.

In a third aspect, one or more of the present embodiments provide a method for decoding a current block comprising the method of the first aspect.

In a fourth aspect, one or more of the present embodiments provide a device comprising electronic circuitry configured for:
obtaining an initial list of motion vector predictors candidates for a motion information of a current block;
obtaining bi-prediction candidates from the initial list, each bi-prediction candidate comprising two motion vectors, a first motion vector of the two motion vectors pointing on a first prediction block in a first reference picture and a second motion vector of the two motion vectors pointing on a second prediction block in a second reference picture;
calculating a score for bi-prediction candidates of the initial list; and,
obtaining a motion vector predictor for the motion information of the current block based on the calculated scores;
wherein each score is value representative of a difference between a first template and a second template, the first template comprising samples of the first prediction block and the second template comprising samples of the second prediction block corresponding spatially to the samples of the first template.

In an embodiment, the electronic circuitry is further configured for re-ordering the bi-prediction candidates of the initial list based on the calculated scores to obtain a re-ordered list, the obtained motion vector predictor being obtained from the re-ordered list.

In an embodiment, the first template comprises all samples of the first prediction block and the second template comprises all samples of the second prediction block.

In an embodiment, the first template corresponds to bottom-right samples of the first prediction block and the second template corresponds to bottom-right samples of the second prediction block.

In an embodiment, the first template corresponds to top-left samples of the first prediction block and the second template corresponds to top-left samples of the second prediction block.

In an embodiment, each template is N pixels thick, N being a positive integer value.

In an embodiment, the electronic circuitry is further configured to apply an integer-based motion compensation to identify the first and the second templates respectively in the first and the second reference pictures.

In an embodiment, a motion vector difference is added to at least one bi-prediction candidates of the initial list before calculating the score.

In an embodiment, responsive to the initial list comprises uni-prediction candidates, only the bi-prediction candidates are re-ordered and each uni-prediction candidate keep a same index in the re-ordered list than in the initial list.

In an embodiment, responsive to the initial list comprises uni-prediction candidates, uni-prediction candidates of the initial list are transformed into a bi-prediction candidates before the calculation of the scores.

In an embodiment, bi-prediction candidates of the re-ordered list obtained from a uni-prediction candidate of the initial list are used for a prediction of the motion information of the current block.

In an embodiment, responsive to the initial list comprises uni-prediction candidates, uni-prediction candidates are excluded from the re-ordered list.

In a fifth aspect, one or more of the present embodiments provide a device for encoding a current block comprising the device of the fourth aspect.

In a sixth aspect, one or more of the present embodiments provide a device for decoding a current block comprising the device of the fourth aspect.

In a seventh aspect, one or more of the present embodiments provide a computer program comprising program code instructions for implementing the method of the first, second or third aspect.

In a eighth aspect, one or more of the present embodiments provide a non-transitory information storage medium storing program code instructions for implementing the method of the first, second or third aspect.

### 5. BRIEF SUMMARY OF THE DRAWINGS

FIG. 1 describes an example of a context in which following embodiments can be implemented.

FIG. 2 illustrates an example of partitioning undergone by an image of pixels of an original video;

FIG. 3 depicts schematically a method for encoding a video stream executed by an encoding module;

FIG. 4 depicts schematically a method for decoding the encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6A illustrates schematically five spatial positions considered for constructing a list of merge candidates;

FIG. 6B illustrates schematically collocated positions considered for determining the temporal motion vector predictor;

FIGS. 7A and 7B illustrates a block-based affine transform motion compensation applied to a block;

FIG. 8 illustrates a sub-block based affine transform prediction;

FIG. 9 illustrates a control point motion vector inheritance;

FIG. 10 illustrates spatial and temporal neighbors used to derive motion information of control points;

FIG. 11 represents spatially neighboring blocks considered in a sub-block temporal motion vector prediction process;

FIG. 12 illustrates an example of a process allowing deriving a sub-block temporal motion vector predictor;

FIG. 13 illustrates a template matching based method;

FIG. 14A illustrates schematically a process of reordering predictors in a list of predictors implemented by an encoding module;

FIG. 14B illustrates schematically a process of reordering predictors in a list of predictors implemented by a decoding module; and,

FIG. 15 illustrates two temporal predictors used to create the final prediction.

### 6. DETAILED DESCRIPTION

The following examples of embodiments are described in the context of a video format similar to VVC (ISO/IEC 23090-3-MPEG-I: Versatile Video Coding (VVC)/ITU-T H.266). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9.

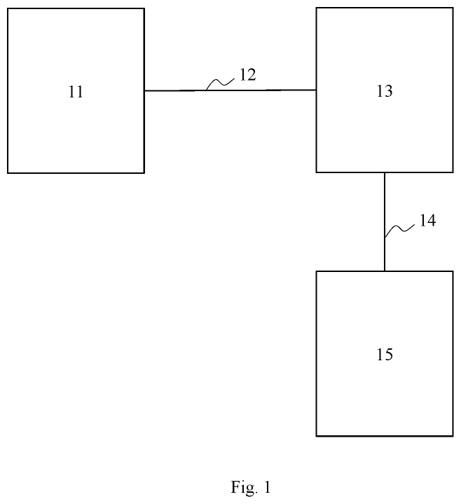

FIG. 1 describes an example of a context in which following embodiments can be implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display 15 are comprised in a TV, a computer, a tablet, a smartphone, a head-mounted display, etc.

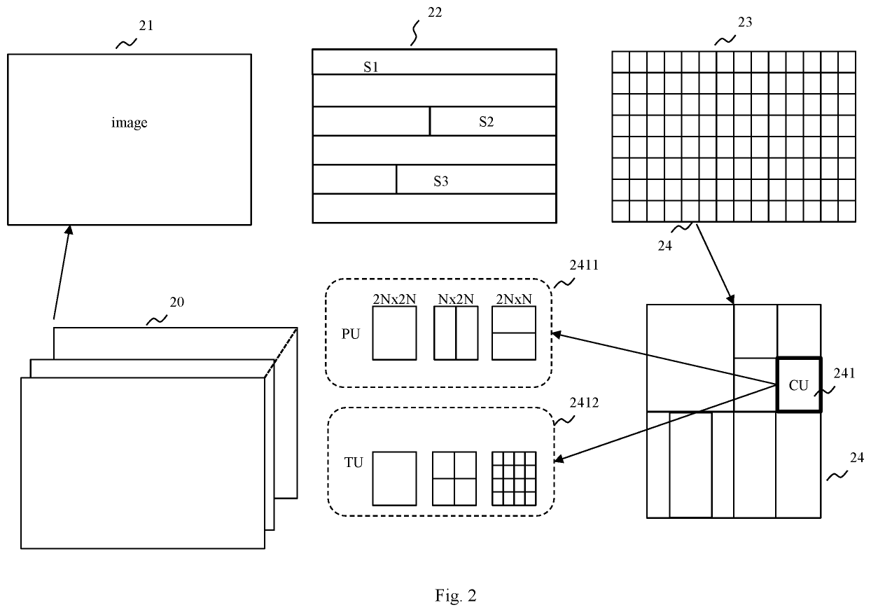

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 1, a CU of size 2N×2N, can be divided in PU 2411 of size N×2N or of size 2N×N. In addition, said CU can be divided in “4” TU 2412 of size N×N or in “16” TU of size (N/2)×(N/2).

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

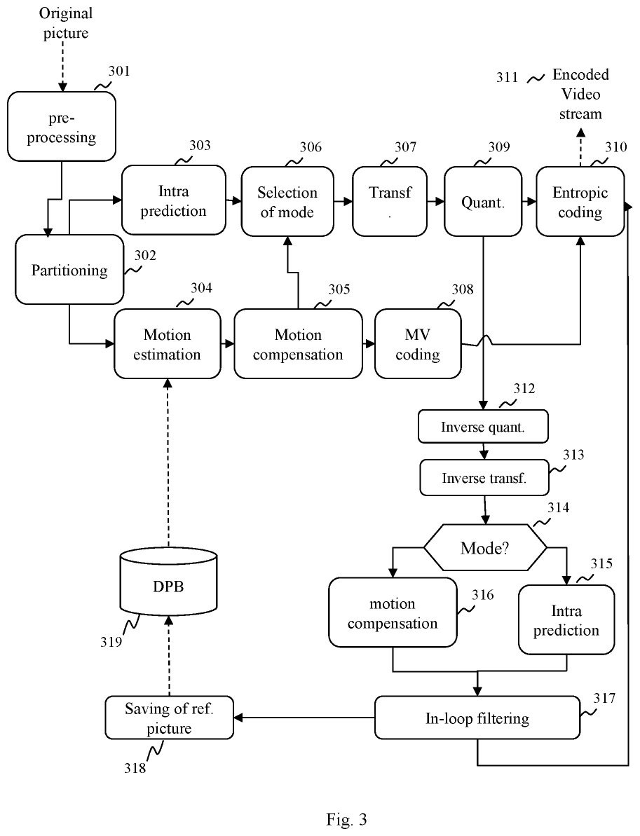

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction mode indicating which pixels of the blocks in the vicinity to use, and a residual block resulting from a calculation of a difference between the current block and the prediction block.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block.

When the current block is encoded according to an inter prediction, a process is applied to encode the motion information.

Two processes are employed to encode the motion information: AMVP (Adaptive Motion Vector Prediction) or Merge. In each process, the motion information are predicted.

In an implementation of the AMVP mode, a motion vector predictor (MVP) is selected, and a motion vector difference noted MVd relative to the selected MVP is computed. The MVP is selected in a list of AMVP candidates made of “2” candidates. The index of the chosen MVP and the MVd are then encoded by the entropic encoder during step 310 along with the transformed and quantized residual block resulting from the inter prediction of the current block.

The AMVP candidate list is constructed first by deriving a first spatial candidate from a left block neighbouring the current block, if this block is available and inter coded. Then a second spatial candidate is derived from a top block neighbouring the current block, if this block is available and inter coded. Then, a temporal candidate is derived from the reference picture considered for the current block at a position collocated with the current block, if an inter block exist at this collocated position. Each derived MVP candidate is scaled according to a temporal distance between the reference picture associated to this MVP candidate and the reference picture considered for the current block. A redundancy check is then conducted between derived spatial candidates and, if a duplicate candidate exists, this candidate is discarded. The final AMVP candidate list contains the two first derived MVP candidates. If less than “2” MVP candidates are obtained through the above process, then the AMVP candidate list is completed with zero motion vectors.

The merge mode consists in deriving motion information of a current block from a selected motion information predictor candidate. The motion information considered here includes all the inter prediction parameters of a block, that is to say: the uni-directional or bi-directional temporal prediction type, the reference picture index within each reference picture list and the motion vector(s). The selected motion information predictor candidate (i.e., the merge candidate) is selected in a list of motion information predictor candidates (i.e., in a list of merge candidates). When a block is encoded in merge mode, the index of the selected merge candidate is encoded. If no residual block is encoded for the current block, the current block is considered as encoded according to a particular merge mode called skip mode.

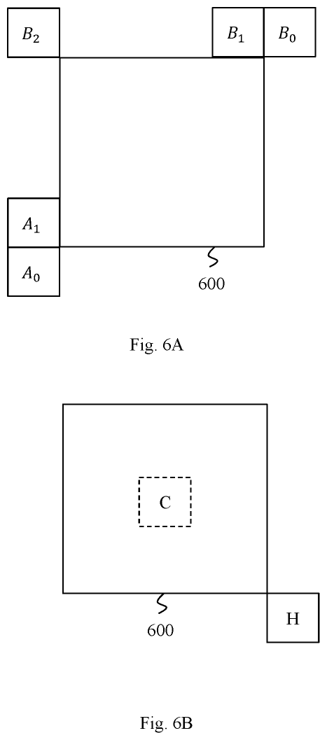

In some implementations, the list of merge candidates is systematically made of “5” merge candidates. Up to “5” spatial positions are considered to retrieve some potential candidates for the list of merge candidates. FIG. 6A illustrates schematically the five spatial positions considered for constructing a list of merge candidates. These positions are investigated according to the following order:
1. Left (A1)
2. Above (B1)
3. Above right (B0)
4. Left bottom (A0)
5. Above left (B2)

Each spatial candidates is introduced in the list of merge candidates provided that the motion information corresponding to this candidate is not already present in the list of merge candidates.

Then a temporal predictor noted TMVP is determined. FIG. 6B illustrates schematically collocated positions considered for determining the TMVP. The determination of the TMVP consists first in investigating position H and, if no motion information is available at position H, the position C is investigated. A scaling may be applied to the obtained motion information to obtain the TMVP.

A last pruning process is then applied to ensure that the set of spatial and temporal candidates does not contain redundant candidates.

In case of B-slice (slice allowing bi-predicted blocks), candidates of another type, called combined candidates, are introduced in the list of merge candidates if this list is not full.

Finally, if the merge list is still not full then zero motion vectors are introduced in at the end of the merge list until it is full.

Recently, the representation of the motion information has slightly evolved with the apparition of two main categories of motion representation: the whole-block-based motion representation and the sub-block-based motion representation.

The whole-block-based motion representation consists in assigning one set of motion information, made of one or two motion vectors and associated reference picture(s) to an inter block. Thus, the motion information of that block is represented under the form of one or two motion vectors for the whole block and a reference picture associated to each motion vector.

Sub-block-based motion coding mode typically consists in dividing a block into 4×4 or 8×8 luma samples subblocks and assigning an individual set of motion information (one or two couples of a motion vector and a reference picture) to each subblock.

While in previous implementations of AMVP only spatial candidates, temporal candidates and the zero-motion vector candidate were considered for constructing the list of AMVP candidates, a new category of candidates, called HMVP (History-Based Motion Vector Prediction) candidates, was added in AMVP implementations adapted to the whole block-based motion representation.

A principle of HMVP candidates is to use previously coded motion vectors as MVPs. These motion vectors are associated with adjacent or non-adjacent blocks relative to a current block. To do so, a table of HMVP candidates (i.e., HMVP table) is maintained and updated on the fly, as a first-in-first-out (FIFO) buffer of MVPs. There are up to five candidates in the HMVP table. After coding one inter predicted block, provided that this block is not in sub-block mode (including affine mode) or GPM (geometric partition mode), the HMVP table is updated by appending the inter predicted block motion information to the end of the HMVP table as a new HMVP candidate. In addition to the usual FIFO rule, a mechanism to remove redundant HMVP candidates is applied. One can note that the HMVP table is reset at each CTU row to enable parallel processing.

In recent implementations of the merge mode adapted to the whole block-based representation, the list of merge candidates was modified and three new merge modes were introduced.

The list of merge candidates is constructed with the following types of candidates:
Spatial candidates.
Temporal candidates.
HMVP candidates. Several HMVP candidates are inserted into the list of merge candidates so that the list reaches a maximum allowed number of merge candidates minus 1.
Pairwise Average candidates. Up to one pairwise average candidate is added to the list of merge candidates. Pairwise candidates are computed as follows: The two first merge candidates present in the list of merge candidates are considered and their motion vectors are averaged. This averaging is computed separately for each reference picture list. If each of the two first merge candidates are bi-prediction ones, motion vectors related to both lists L0 and LI are averaged. If only one motion vector is present, it is taken as is to form the pairwise candidate.
5. Zero motion vector candidate.

The three new merge modes comprise MMVD (Merge Mode with motion vector Difference), GPM (Geometric Partitioning Mode) and CIIP (Combined Intra/Inter Prediction). These new modes are detailed in document JVET-T2002-v2: Algorithm description for Versatile Video Coding and Test Model 11 (VTM 11), Joint Video Experts Team (JVET) of ITU-T SG 16 WP 3 and ISO/IEC JTC 1/SC 29, 20th Meeting, by teleconference, 7-16 Oct. 2020, Jianle Chen, Yan Ye, Seung Hwan Kim.

MMVD can be viewed as a king of merge mode in which a merge candidate is refined by a MVd. In MMVD, after a merge candidate is selected, it is further refined by a signalled MVd information. The signaling of a MMVD mode comprises a merge candidate flag, an index to specify a motion magnitude and an index indicating a motion direction. The merge candidate flag is signalled to specify which one is used between the first and second merge candidates. The index specifying a motion magnitude and the index indicating a motion direction allow signaling a limited number of motion vector differences (MVd) on top of a signaled merge candidate, i.e., “4” vector directions and “8” magnitude values.

As video compression standards evolve, the family of inter modes has grown significantly and comprises now many different inter modes.

For instance, it had been observed that a translational motion model cannot represent accurately motions such as zoom in/out, rotation, perspective motions and other irregular motions. To deal with this issue, in some implementations, a block-based affine transform motion compensation prediction had been proposed.

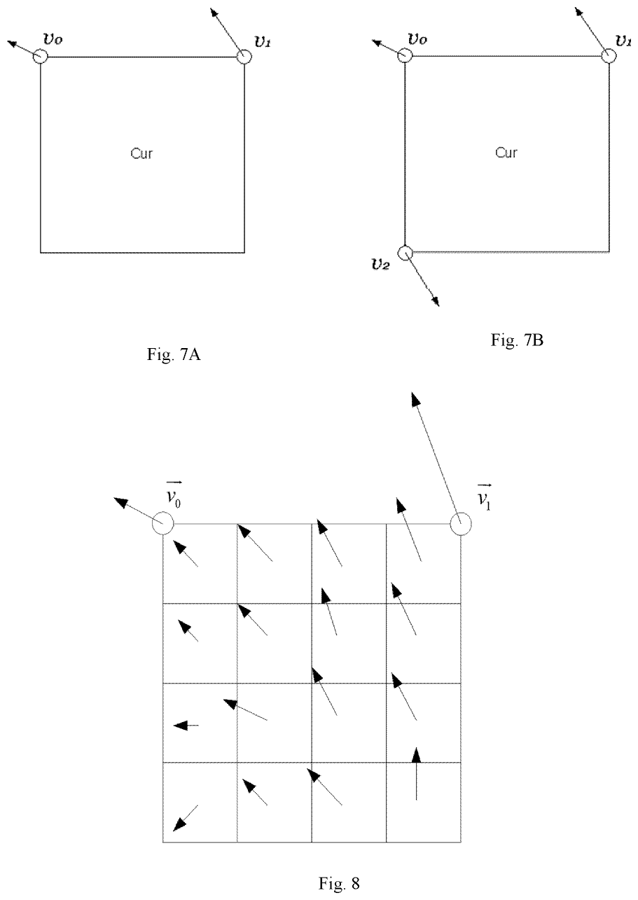

FIGS. 7A and 7B illustrates a block-based affine transform motion compensation applied to a current block Cur. As shown in FIGS. 6A and 6B, an affine motion field of the current block is described by motion information of two control point motion vectors (CPMVs) (4-parameter) in FIG. 7A or three control point motion vectors (6-parameter) in FIG. 7B.

For the 4-parameter affine motion model, a motion vector at sample location (x, y) in the current block is derived as follows:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad Eq . 1$$

For the 6-parameter affine motion model, the motion vector at the sample location (x, y) in the current block is derived as follows:

$$\{ \begin{matrix}m {v}_{x} = \frac{m {v}_{1 x} - m {v}_{0 x}}{W} x + \frac{{m}_{2 x} - {mv}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad Eq . 2$$

Where (mv₀ₓ, mv_{0y}) is a motion vector at a top-left corner control point of the current block, (mv₁ₓ, mv_{1y}) is a motion vector at a top-right corner control point of the current block, and (mv₂ₓ, mv_{2y}) is a motion vector of a bottom-left corner control point of the current block.

In order to simplify the motion compensation prediction, a sub-block based affine transform prediction had been proposed.

FIG. 8 illustrates a sub-block based affine transform prediction. To derive a motion vector for each 4×4 luma sub-block of a current block, a motion vector of a center sample of each sub-block is calculated according to equations Eq. 1 or Eq. 2 and rounded to 1/16 fraction accuracy. Then, motion compensation interpolation filters are applied to generate the prediction of each subblock with the derived motion vector. The sub-block size of chroma-components is also set to be 4×4. The motion vector of a 4×4 chroma subblock is calculated as the average of the motion vectors of the top-left and bottom-right luma sub-blocks in a collocated 8×8 luma region.

As done for translational motion inter prediction, there are also two affine motion inter prediction modes: affine merge mode and affine AMVP mode.

In the affine merge mode, the control point motion vectors (CPMVs) of a current block are generated based on the motion information of spatial neighboring blocks. There can be up to five CPMV predictor (CPMVP) candidates and an index is signalled to indicate the one to be used for the current block. The following three types of CPVM candidates are used to form a list of affine merge candidates:
Inherited affine merge candidates extrapolated from the CPMVs of the neighbour affine blocks;
Constructed affine merge candidates CPMVPs that are derived using the translational motion vectors of the neighbour blocks;
Zero motion vectors.

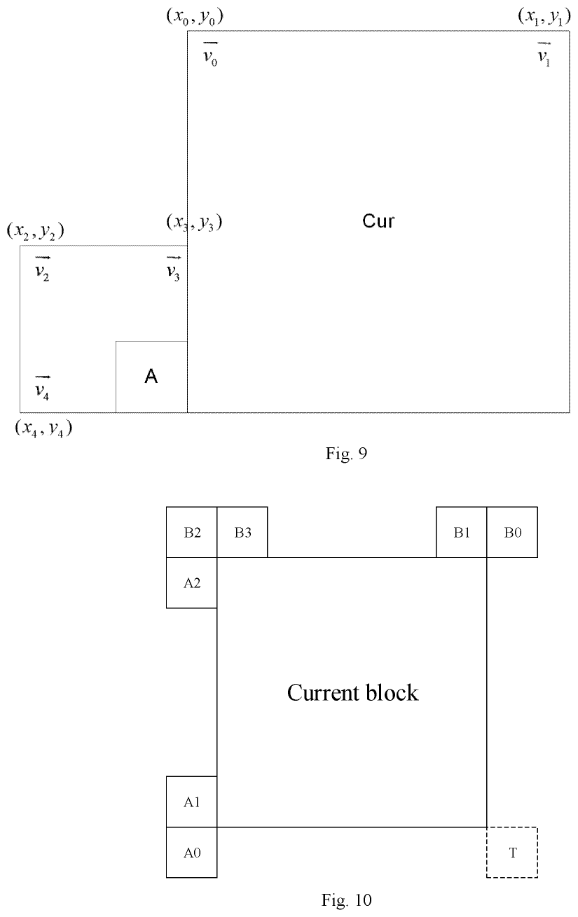

In some implementations, there are maximum two inherited affine candidates which are derived from affine motion model of the neighboring blocks, one from left neighboring blocks and one from above neighboring blocks. The candidate blocks are shown in FIG. 6A. For the left predictor, the scan order is A0->A1, and for the above predictor, the scan order is B0->B1->B2. Only the first inherited candidate from each side is selected. No pruning check is performed between two inherited candidates. When a neighboring affine block is identified, its CPMVs are used to derive the CPMVP candidate in the affine merge list of the current block. As shown in FIG. 9, if the neighbour left bottom block A is coded in affine mode, the motion vectors v₂, v₃ and v₄ of the top left corner, above right corner and left bottom corner of a block which contains the block A are attained. When block A is coded with a 4-parameters affine model, the two CPMVs of the current block are calculated according to v₂ and v₃. In case that block A is coded with a 6-parameters affine model, the three CPMVs of the current CU are calculated according to v₂, v₃ and v₄.

Constructed affine candidate means the candidate is constructed by combining the neighbor translational motion information of each control point. The motion information for the control points is derived from specified spatial and temporal neighbors represented in FIG. 10. CPMVₖ (k=1, 2, 3, 4) represents the k-th control point. For CPMV₁, the B2->B3->A2 blocks are checked and the motion vector of the first available block is used. For CPMV₂, the B1->B0 blocks are checked and for CPMV₃, the A1->A0 blocks are checked. TMVP is used as CPMV₄ if it's available.

After motion vectors of four control points are attained, affine merge candidates are constructed based on these motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of three CPMVs constructs a 6-parameters affine merge candidate and the combination of 2 CPMVs constructs a 4-parameters affine merge candidate. To avoid motion scaling process, if the reference indices of control points are different, the related combination of control point MVs is discarded.

After inherited affine merge candidates and constructed affine merge candidate are checked. If the list is still not full, zero motion vectors are inserted to the end of the list.

In addition, some implementations proposed a sub-block merge mode. The sub-block merger mode uses a sub-block temporal motion vector prediction to generate a sub-block temporal motion predictor (SbTMVP). The SbTMVP differs from a regular TMVP (RTMVP), as described above, in the following two main aspects:
the RTMVP predicts motion at block level while the SbTMVP predicts motion at sub-block level;
whereas the RTMVP is derived from a collocated block in the collocated picture, the position of the current block is first shifted before deriving the SbTMVP from a block collocated with the shifted position of the current block of the collocated picture. The shift, called motion shift in the following, is obtained from a motion vector of a block spatially neighboring the current block.

FIG. 12 illustrates an example of a process allowing deriving the sub-block temporal motion vector predictor.

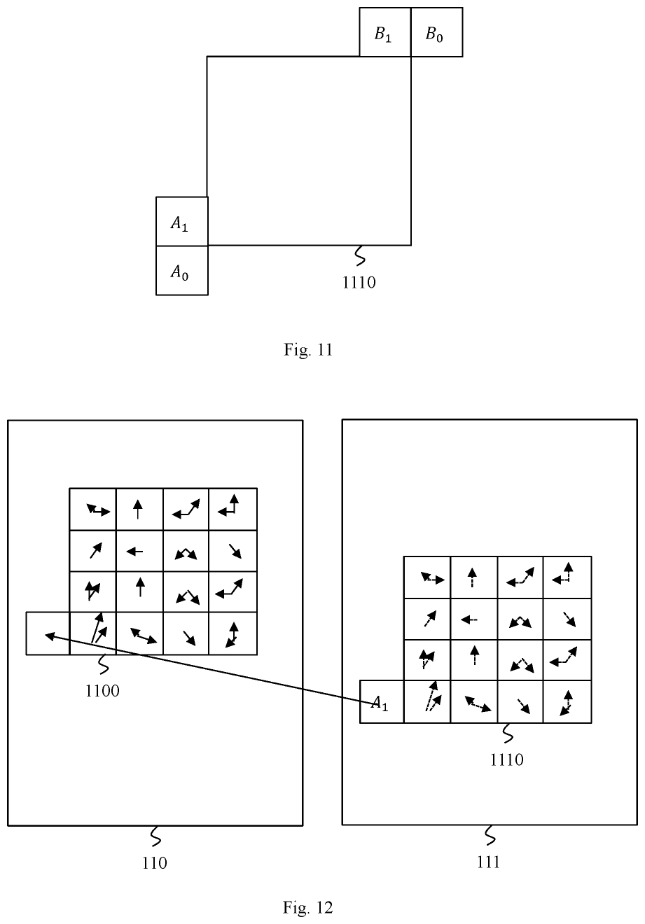

The sub-block motion vector prediction predicts the motion vectors of sub-blocks within a current block 1110 of a current picture 111 in two steps:
In the first step, blocks spatially neighboring the current block 1110 are examined. FIG. 11 represents the spatially neighboring blocks considered in the sub-block temporal motion vector prediction process. As can be seen in FIG. 11, four blocks are considered, two blocks A1 and A0 located on the bottom left corner of the current block 1110 and two blocks B1, B0 located at the upper right corner of the current block 1110. The spatially neighboring blocks are examined in the order A1, B1, B0 and A0. In this order, as soon as a spatially neighboring block having a motion vector pointing to the collocated picture 110 is identified, this motion vector is selected to be the motion shift to be applied. If no such motion vector is identified from the spatially neighboring blocks A1, B1, B0 and A0, then the motion shift is set to (0, 0), i.e. no motion.
In the second step, the motion shift identified in the first step is applied to the position of the current block 1110 (i.e. added to the current block 1110 coordinates). Then, sub-block-level motion data (motion vectors and reference indices) are derived from a current block 1100 of the collocated picture 110 collocated with the shifted position of the current block 1110. In the example of FIG. 12, the motion shift is assumed to be set to the motion of block A1. For each sub-block of the current block 1110, the motion data of its corresponding sub-block (the smallest motion grid that covers the center sample) in the block 1100 is used to derive the motion data for said sub-block of the current block 1110. The SbTMVP derivation is then finalized by applying a temporal motion vector scaling to the motion vectors derived for each sub-block to align the reference pictures of these derived motion vectors to that of the current block 1110. For each sub-block, the scaled motion vector is used as a motion vector for the sub-block.

The sub-block size used in SbTMVP is generally 8×8. In that case, SbTMVP mode is only applicable to blocks having a width and a height larger than or equal to “8”.

In some implementations, a combined sub-block-based merge list which contains both SbTMVP candidate and affine merge candidates is used for the signalling of sub-block-based merge mode. The SbTMVP mode is enabled/disabled by a sequence parameter set (SPS) flag. If the SbTMVP mode is enabled, the SbTMVP predictor is added as the first entry of the list of sub-block-based merge candidates, and followed by the affine merge candidates. The size of the sub-block-based merge list is signalled in SPS and the maximum allowed size of the sub-block-based merge list is generally “5”.

In order to further improve the compression efficiency of the motion information, some implementations reduces the bitrate of the motion information by letting decoders determining a part of said motion information. For instance, it is proposed to let a decoder refining the motion information. To keep the consistency between the encoder and the decoder, processes applied on the decoder side are replicated identically on the encoder side.

Some methods allowing refining the motion information are based on template matching.

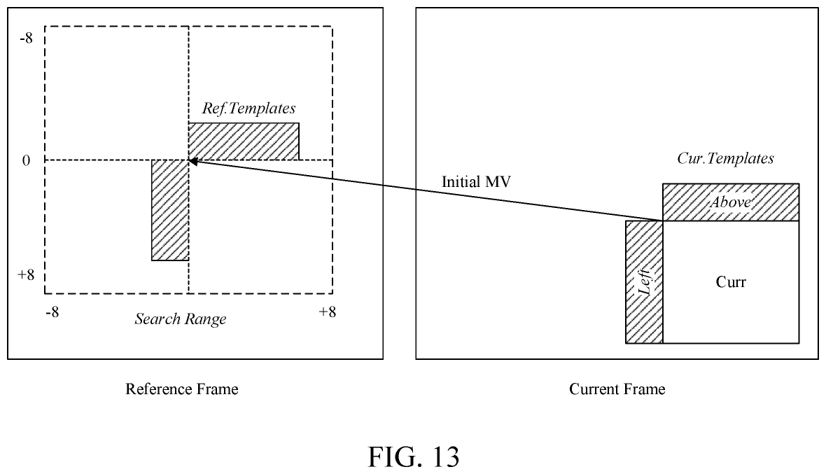

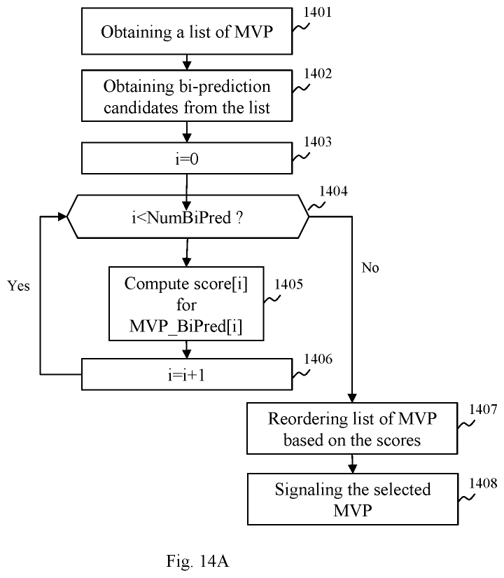

Template matching (TM) is a decoder-side motion vector derivation method to refine the motion information of a current block by finding a closest match between a template (i.e. a set of reconstructed samples) neighboring the current block in the current picture and a reference template in a reference picture. FIG. 13 illustrates a template matching based method. As illustrated in FIG. 13, a better motion vector is searched around an initial motion vector of a current block Curr within a [−8, +8]-pel search window.

In AMVP mode, a motion vector predictor candidate is determined based on template matching error to select the one which reaches the minimum difference between the current block template and the reference block template. Then TM is performed only for this particular motion vector predictor candidate for motion vector refinement. TM refines this motion vector predictor candidate, starting from full-pel motion vector difference precision within a [−8, +8]-pel search window by using iterative diamond search. The obtained motion vector predictor candidate may be further refined by using cross search with full-pel motion vector difference precision, followed sequentially by half-pel and quarter-pel ones. In the search process, if the difference between the previous minimum cost and the current minimum cost in the iteration is less than a threshold that is equal to the area of the block, the search process terminates.

In merge mode, similar search method is applied to the merge candidate indicated by a merge index.

TM can also be used to reorder adaptively merge candidates proposed in the method Adaptive reordering of merge candidates with template matching (ARMC-TM) described in section 2.7 of document JVET-X2025-V2: Algorithm description of Enhanced Compression Model 3 (ECM 3), Muhammed Coban, Joint Video Experts Team (JVET), of ITU-T SG 16 WP 3 and ISO/IEC JTC 1/SC 29, 23rd Meeting, by teleconference, 7-16 Jul. 2021.

After a merge candidate list is constructed, merge candidates are divided into several subgroups. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

For sub-block-based merge candidates with sub-block size equal to Wsub×Hsub, a template above a current block comprising the sub-block is divided in several sub-templates with the size of Wsub×1, and a template on the left of the current block is divided in several sub-templates with the size of 1×Hsub. The motion information of the sub-blocks in the first row and the first column of current block is used to derive the reference samples of each sub-template.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. In some implementations, a plurality of type of transforms can be applied to a transformed residual block. Indeed, in addition to DCT-II, a Multiple Transform Selection (MTS) scheme is used for both inter and intra predicted blocks. It uses multiple selected transforms from the DCT-VIII/DST-VII.

The transformed block is then quantized during a step 309.

Note that the encoding module can skip the transform and apply quantization directly to the non-transformed residual signal.

The quantized residual block determined for the current block during an inter or intra prediction is encoded by an entropic encoder during a step 310. Note that the encoding module can bypass both transform and quantization, i.e., the entropic encoding is applied on the residual without the application of the transform or quantization processes. The result of the entry coding is inserted in the video data 311.

When the current block is coded according to an intra prediction mode, the intra prediction mode is encoded by the entropic encoder during the step 310 in the video data 311.

When the current block is encoded according to an inter prediction, the inter mode and the result of the process applied to encode the motion information are then encoded by the entropic encoder during the step 310 in the video data 311.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion information of the current block in order to identify each reference block of the current block. If the current block is encoded according to an intra prediction mode, during a step 315, the intra prediction mode is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

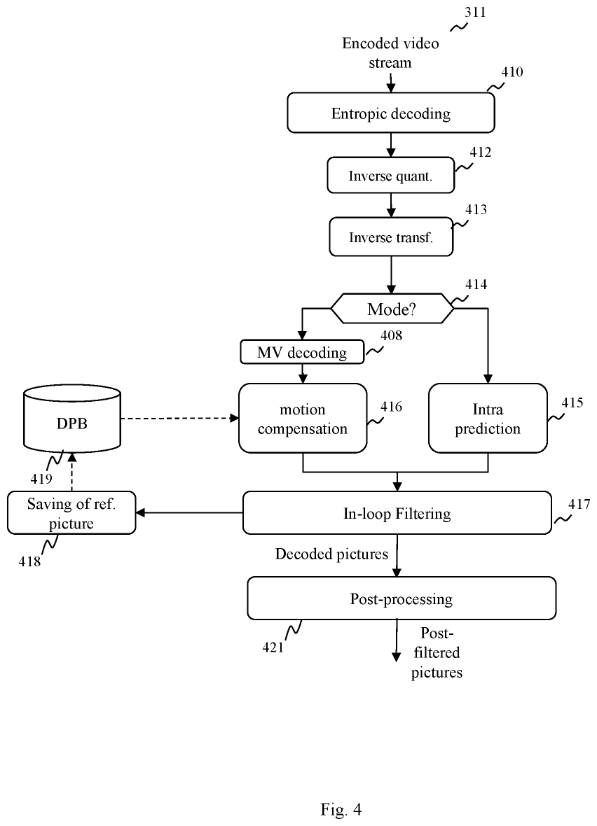

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the current block has been encoded according to an inter prediction mode, the entropic decoding allows to obtain, when appropriate, information representative of a motion of the current block and a residual block. During a step 408, the motion information is reconstructed for the current block using the decoded information representative of the motion information.

If the inter prediction mode applied involve a decoding side motion vector refinement, the specified refinement process is applied to the motion information of the current block. When the decoding side motion vector refinement process is based on templates involving samples of reconstructed blocks neighbouring the current block, dependencies are created between the neighbouring blocks and the current block. These dependencies may prevent from parallelizing the processing of the current and the neighbouring blocks. As can be seen, inter blocks based on templates introduce decoding latencies compared to inter mode not based on templates.

If the block has been encoded according to an intra prediction mode, entropic decoding allows to obtain the intra prediction mode and a residual block. Steps 412, 413, 414, 415, 416 and 417 implemented by the decoding module are in all respects identical respectively to steps 412, 413, 414, 415, 416 and 417 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given image. The decoded picture can also be outputted by the decoding module for instance to be displayed.

The post-processing step 421 can comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

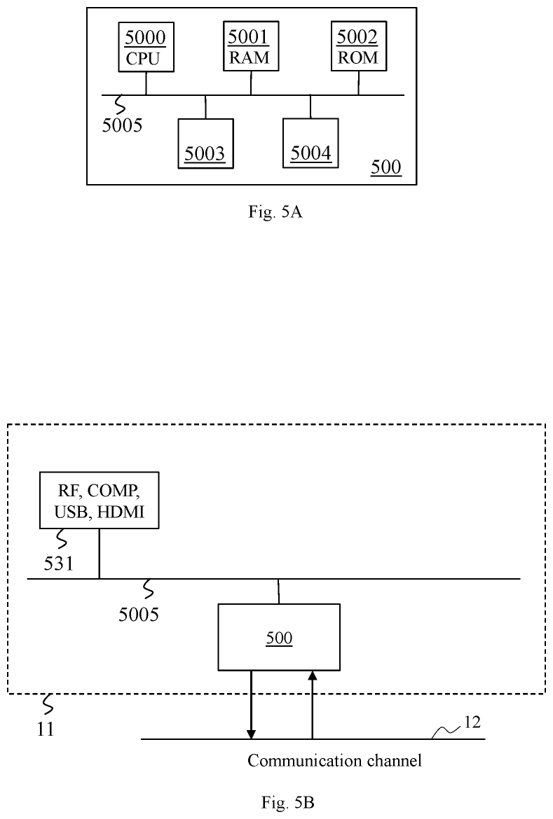

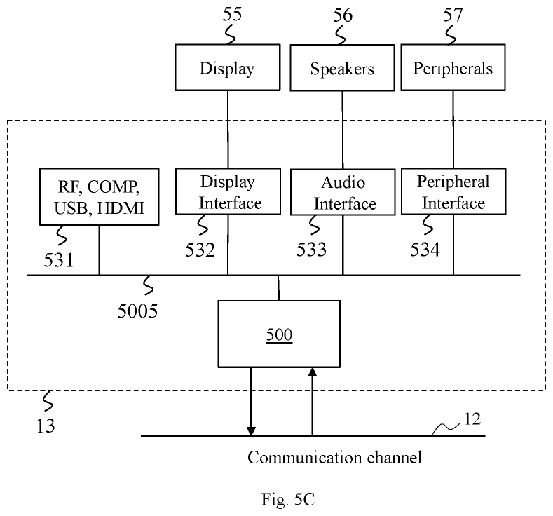

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this apparatus is in charge of encoding the video stream. The decoding module is for example comprised in the system 13. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

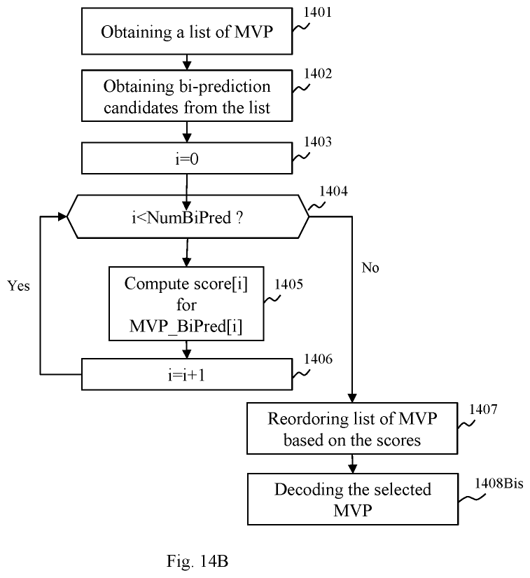

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4, an encoding method described in relation to FIG. 3, and methods described in relation to FIG. 14A or 14B, these methods comprising various aspects and embodiments described below in this document.

All or some of the algorithms and steps of the methods of FIGS. 3, 4, 14A and 14B may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 3, 4, 14A and 14B.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5D, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 52. As already mentioned above, the communication channel 52 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 55, speakers 56, and other peripheral devices 57. The display system 55 of various embodiments includes one or more of, for example, a touchscreen display, an organic light-emitting diode (OLED) display, a curved display, and/or a foldable display. The display 55 can be for a television, a tablet, a laptop, a cell phone (mobile phone), a head mounted display or other devices. The display system 55 can also be integrated with other components (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 13. For example, a disk player performs the function of playing an output of the system 13.

In various embodiments, control signals are communicated between the system 13 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 52 via the communications interface 5004 or a dedicated communication channel corresponding to the communication channel 54 in FIG. 5A via the communication interface 5004. The display system 55 and speakers 56 can be integrated in a single unit with the other components of system 13 in an electronic device such as, for example, a television. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5B illustrates a block diagram of an example of the system 51 in which various aspects and embodiments are implemented. System 51 is very similar to system 13. The system 51 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 51, singly or in combination, can be embodied in a single integrated circuit (IC), multiple ICs, and/or discrete components. For example, in at least one embodiment, the system 51 comprises one processing module 500 that implements an encoding module. In various embodiments, the system 51 is communicatively coupled to one or more other systems, or other electronic devices, via, for example, a communications bus or through dedicated input and/or output ports. In various embodiments, the system 51 is configured to implement one or more of the aspects described in this document.

The input to the processing module 500 can be provided through various input modules as indicated in block 531 already described in relation to FIG. 5D.

Various elements of system 51 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 51, the processing module 500 is interconnected to other elements of said system 51 by the bus 5005.

The communication interface 5004 of the processing module 500 allows the system 500 to communicate on the communication channel 52.

Data is streamed, or otherwise provided, to the system 51, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 51 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 51 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 51 or comprised in the system 51. In that case, the processing module take in charge the encoding of these data.

The system 51 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for re-ordering a list of motion vector predictors.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for re-ordering a list of motion vector predictors.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In the following, embodiments are proposed for increasing the parallelization possibilities of operations in a decoding process. A low complexity reordering criteria for bi-prediction motion candidates is introduced. A use of this criteria allows avoiding the latency issue brought by known template matching based re-ordering methods.

FIG. 14A illustrates schematically a process of reordering predictors in a list of predictors implemented by an encoding module.

The process of FIG. 14A is for example implemented by the processing module 500 of the system 11 when the system 11 implements an encoding module implementing for instance the encoding method of FIG. 3. The process of FIG. 14A is for instance executed during step 304 if the encoding of the motion information is taken into account in the mode selection of step 306. In any case, the process of FIG. 14A is executed during step 308 for the encoding of the motion information.

In a step 1401, the processing module 500 obtains a list of motion vector predictors candidates. The list is for instance a list of merge candidates, a list of affine merge candidates, etc.

In a step 1402, the processing module 500 obtains bi-prediction candidates from the list.

In a step 1403, the processing module 500 initialize a variable i to zero.

In a step 1404, the processing module 500 determines if the variable i is lower than a number of bi-prediction candidates in the list NumBiPred.

If yes, the processing module 500 continues with a step 1405.

In step 1405, the processing module 500 calculates a score score[i] for a i-est bi-prediction candidate MVP_BiPred[i]. Similarly to the TM based methods, the score of bi-prediction candidate is a value representative of a difference between two templates. However, to avoid latencies observed in traditional TM based method and allow parallelization the processing of consecutive inter predicted blocks, the template is located inside each of the two predictions which does not depend on the reconstruction of the current slice comprising the current block.

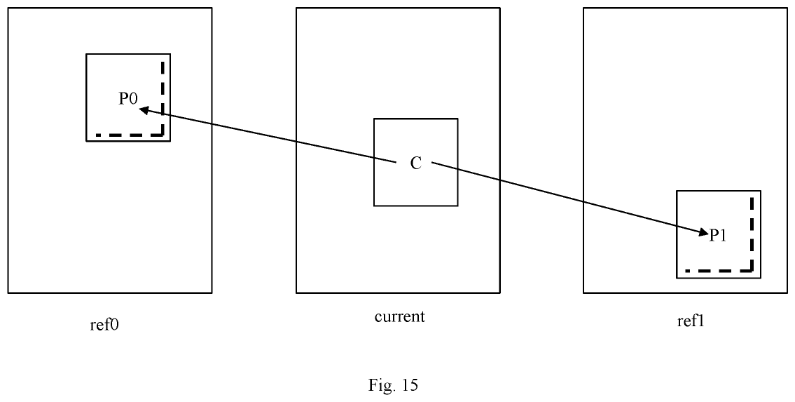

For example, in FIG. 15, for a current block C in the current picture, two temporal predictors are used to create the final prediction: P0 is the block C displaced in reference picture ref0 and P1 the displaced block in reference picture ref1. The prediction P0 or P1 are not necessarily created by applying a uniform motion on the whole block, but can be sub-block-based motion model (e.g. affine or SbTMVP).

For each prediction (i.e., PO and P1), a template T is created containing the motion compensated samples. An error metric representative of a difference between the template T⁰ extracted from the prediction P0 and the template T¹ extracted from the prediction P1 is used to compute the score of the candidate MVP_BiPred[i] for example as follows:

$$D = {\sum }_{i} \vert {T}_{i}^{0} - {T}_{i}^{1} \vert$$

Here, the score is computed as a SAD (sum of Absolute Difference) between the two templates. However, other metrics can be used such as the sum of the Square Difference (SSD) or a weighted sum of absolute differences where weights are sample-position dependent.

The main advantage of using the samples inside the predictions is that it does not introduce latency in the pipeline, since the samples are already available when decoding the current Block C (whereas for traditional TM based methods, one must wait for neighboring block to be reconstructed).

In a variant, instead of using a template corresponding to a whole prediction block to compute the score, the score is computed on a sub-part of the prediction blocks. In FIG. 15, a bottom-right template is used. The main advantage of this location is that, if the candidate has non consistent motion between the “2” predictors, then it is likely to be more different at the bottom right location than at the top-left location. Indeed, the candidates are usually coming from neighboring blocks, so the motion near the top and left border are likely to be correlated with the motion of the top or left blocks. By using a template far from theses borders, we increase a probability to reject bad candidates.

In a variant, in another hand, in order to have similar behavior as current template matching, one may chose using top-left reconstructed samples. Favoring some samples in the difference computation may also be carried out using sample-based difference weighting, with larger weights for area to favor.

In a variant, the template size is chosen to be only N pixels thick (for example N=1) in order to minimize the complexity.

In a variant, the motion compensation of the template is simplified and an integer-based motion compensation (copy of the pixel) based on a nearest integer motion is computed. In another variant, a low complexity filtering (eg. Bilinear filter) is used to perform the motion compensation of the template samples.

One can note that in case of motion vector predictor candidates where a motion correction (mvd) is added before the motion compensation (for example in AMVP mode or MMVD candidates), then the motion vector difference mvd is added on top of each candidate before computing the score.

One can further note that, in some case a current block can be temporally predicted from more than two reference blocks (i.e., a current block can be predicted from more than two predictions). In that case, it is no more a bi-predicted block but a multi-predicted block. When more than two predictions are available, the score is the normalized (by the number of pair of predictions) score between each pair of predictions or an average or a weighted average of the scores between each pair of predictions.

In a step 1406, the processing module 500 increments i of one unit.

If during step 1404, i is equal to the number of bi-prediction candidates in the list NumBiPred, step 1404 is followed by a step 1407.

In step 1407, the processing module 500 re-orders the bi-prediction candidates of the list based on the computed scores to obtain a re-ordered list. The bi-prediction candidates are re-ordered from the lowest score to the highest score.

In a step 1408, the processing module 500 signals an index of the motion vector predictor of the re-ordered list selected for predicting the motion information of the current block. One can note that no index is signaled if the selected motion vector predictor is in first position in the re-ordered list.

FIG. 14B illustrates schematically a process of reordering predictors in a list of predictors implemented by an decoding module.

The process of FIG. 14B is for example implemented by the processing module 500 of the system 13 when the system 13 implements a decoding module implementing for instance the decoding method of FIG. 4. The process of FIG. 14B is for instance executed during step 408.

Steps 1401 to 1407 described in relation to FIG. 14A are applied identically during the process of FIG. 14B.

Step 1408 is replaced by a step 1408Bis.

During step 1408Bis, the index of the motion vector predictor of the re-ordered list is decoded by the processing module 500. If no index is signaled, the processing module 500 determined that the selected motion vector predictor is in first position in the re-ordered list.

In a first variant, in step 1407, if the list also contains uni-prediction candidates, only the bi-prediction candidates are re-ordered and the uni-prediction candidates keep the same index in the re-ordered list than in the “initial” list.

TABLE TAB1

| index | candidate |
|---|---|
| 0 | Uni0 |
| 1 | Bi0 |
| 2 | Bi1 |
| 3 | Uni1 |
| 4 | Bi2 |
| 5 | Bi3 |

TABLE TAB2

| index | candidate |
|---|---|
| 0 | Uni0 |
| 1 | Bi3 |
| 2 | Bi0 |
| 3 | Uni1 |
| 4 | Bi2 |
| 5 | Bi1 |

Table TAB1 illustrates an “initial” list (before re-ordering). Table TAB2 illustrates a re-ordered list according to the first variant of step 1407.

In a second variant, between step 1401 and 1402, uni-prediction candidates of the “initial” list are transformed into a bi-prediction candidates using a symmetrisation of the motion vector with respect to the current picture comprising the current block. For example, if the current frame has POC (Picture Order Count) equal to “8” and a uni-prediction candidate has a motion mv pointing to a reference picture with POC equal to “12”, it is transformed, when possible, into a bi-prediction candidate where the second prediction uses a motion-mv and a reference frame with POC equal to “4” (i.e., symmetric of “12” with respect to “8”). The obtained bi-prediction candidates replaces then the uni-prediction candidates in the “initial” list as replacement bi-prediction candidates before continuing the processes of FIG. 14A or 14B with step 1402 to 1408 (respectively 1408Bis). These replacement bi-prediction candidates are used for re-ordering to obtain the re-ordered list but once re-ordered, replacement bi-prediction candidates are replaced back by the uni-prediction candidates that have replaced in the re-ordered list for the prediction of the motion information of the current block.

In a third variant, when the bi-prediction re-ordering mode is used, the uni-prediction candidates are never inserted in the re-ordered list.

In a fourth variant, when the bi-prediction re-ordering mode is used, the uni-prediction candidates are transformed into bi-prediction candidates (using the method above) and the bi-prediction information is also used to perform the prediction of the motion information of the current block (and not only for the list re-ordering).

In a fifth variant, when it is not possible to convert a uni-prediction into a bi-prediction because no reference picture is available with targeted Picture Order Count, then the picture the closest to the current picture is chosen, and the motion vector pointing to that closest picture is computed with an ad hoc scaling of the uni-prediction motion vector, accounting for respective temporal distance to the two considered reference pictures.

In a sixth variant, uni-prediction candidates are replaced by bi-prediction candidates as in the second variant, but the reordering step 1407 is not applied. An average minimal distortion minDist per sample may be signaled in the video data 311. The error metric D representative of the difference between the template T⁰ and the template T¹ is computed sequentially for each candidate of the “initial” list (following the order of the “initial” list). As soon as one candidate has a value of the error metric D inferior or equal to minDis×N where N is the number of samples in the template, then the candidate is selected for computing the prediction and the other candidates are not tested. This has advantage to reduce complexity with minimal reduction of performance. The value of “minDist” may be signaled per slice, picture or CTU for example. Note that the error metric could be also computed on a subset of samples of the templates T⁰ and T¹.

In a seventh variant, uni-prediction candidates are replaced by bi-prediction candidates as in the second variant, but the reordering step 1407 is not applied. In this seventh variant, a maximum distortion maxDist per sample is used to filter candidates with a difference above a threshold: only candidates with a value of error metric D inferior or equal to maxDist×N, are considered in the initial list. The value of “maxDist” may be fixed or signaled per slice, picture or CTU for example.

One can note that an approach similar to the sixth or seventh variant can be applied to usual TM based approach. However, in that case, there is no need to replace uni-prediction candidates by bi-prediction candidates. Indeed, since templates are external to blocks (i.e., external to the current block and external to the reference blocks), the distortion D for a uni-prediction candidate can be computed between a template neighboring the current block and a template neighboring the reference block pointed by the uni-prediction candidate.

In a eighth variant, a high level syntax, for instance at the SPS level, PPS level, picture header level or in a slice header, indicates that the process of reordering predictors of FIG. 14A is applied by the encoding module and that the process of reordering predictors of FIG. 14B is to be applied by the decoding module.

In a nineth variant, a syntax element, for instance at the CTU level or block level, indicates that the process of reordering predictors of FIG. 14A is applied by the encoding module for a corresponding CTU or block and that the process of reordering predictors of FIG. 14B is to be applied by the decoding module for the same CTU or block.

Further, embodiments can include one or more of the following features, devices, or aspects, alone or in any combination, across various claim categories and types:
Inserting in a signaling syntax elements that enable the decoder to identify the motion vector predictor to use;
A bitstream or signal that includes syntax conveying information generated according to any of the embodiments described;
Inserting in the signaling syntax elements that enable the decoder to adapt motion vector prediction in a manner corresponding to that used by an encoder;
Creating and/or transmitting and/or receiving and/or decoding a bitstream or signal that includes one or more of the described syntax elements, or variations thereof;
A method, process, apparatus, medium storing instructions, medium storing data, or signal according to any of the embodiments described;
A TV, set-top box, cell phone, tablet, or other electronic device that performs motion vector prediction according to any of the embodiments described;
A TV, set-top box, cell phone, tablet, or other electronic device that performs motion vector prediction according to any of the embodiments described, and that displays (e.g. using a monitor, screen, or other type of display) a resulting image;
A TV, set-top box, cell phone, tablet, or other electronic device that selects (e.g. using a tuner) a channel to receive a signal including an encoded image, and performs motion vector prediction according to any of the embodiments described;
A TV, set-top box, cell phone, tablet, or other electronic device that receives (e.g. using an antenna) a signal over the air that includes an encoded image, and performs motion vector prediction according to any of the embodiments described.

1. A method for obtaining a motion vector predictor for motion information of a current block of a picture comprising:
obtaining an initial list of motion vector predictors candidates for the motion information of the current block;
obtaining bi-prediction candidates from the initial list, each bi-prediction candidate comprising two motion vectors, a first motion vector of the two motion vectors pointing on a first prediction block in a first reference picture and a second motion vector of the two motion vectors pointing on a second prediction block in a second reference picture;
calculating a score for the bi-prediction candidates of the initial list; and,
obtaining the motion vector predictor for the motion information of the current block based on the calculated scores;
wherein each score is a value representative of a difference between a first template and a second template, the first template corresponding to bottom-right samples of the first prediction block and the second template corresponding to bottom-right samples of the second prediction block corresponding spatially to the samples of the first template.

2. The method of claim 1 comprising re-ordering the bi-prediction candidates of the initial list based on the calculated scores to obtain a re-ordered list, the obtained motion vector predictor being obtained from the re-ordered list.

3-5. (canceled)

6. The method of claim 1 wherein each template is N pixels thick, N being a positive integer value.

7. The method of claim 1 wherein an integer-based motion compensation is applied to identify the first and the second templates respectively in the first and the second reference pictures.

8. The method of claim 1 wherein a motion vector difference is added to at least one of the bi-prediction candidates of the initial list before calculating the score.

9. The method of claim 2 wherein, responsive to the initial list comprising uni-prediction candidates, only the bi-prediction candidates are re-ordered and each uni-prediction candidate keeps a same index in the re-ordered list as in the initial list.

10. The method of claim 1 wherein, responsive to the initial list comprising uni-prediction candidates, uni-prediction candidates of the initial list are transformed into a bi-prediction candidates before the calculation of the scores.

11. The method of claim 10 wherein, bi-prediction candidates of a re-ordered list obtained from a uni-prediction candidate of the initial list are used for a prediction of the motion information of the current block.

12. The method of claim 2 wherein, responsive to the initial list comprises uni-prediction candidates, uni-prediction candidates are excluded from the re-ordered list.

13. A method for encoding a current block comprising the method of claim 1.

14. A method for decoding a current block comprising the method of claim 1.

15. A device for obtaining a motion vector predictor for motion information of a current block of a picture comprising electronic circuitry configured for:
obtaining an initial list of motion vector predictors candidates for the motion information of the current block;
obtaining bi-prediction candidates from the initial list, each bi-prediction candidate comprising two motion vectors, a first motion vector of the two motion vectors pointing on a first prediction block in a first reference picture and a second motion vector of the two motion vectors pointing on a second prediction block in a second reference picture;
calculating a score for the bi-prediction candidates of the initial list; and,
obtaining the motion vector predictor for the motion information of the current block based on the calculated scores;
wherein each score is a value representative of a difference between a first template and a second template, the first template corresponding to bottom-right samples of the first prediction block and the second template corresponding to bottom-right samples of the second prediction block corresponding spatially to the samples of the first template.

16. The device of claim 15 wherein the electronic circuitry is further configured for re-ordering the bi-prediction candidates of the initial list based on the calculated scores to obtain a re-ordered list, the obtained motion vector predictor being obtained from the re-ordered list.

17-19. (canceled)

20. The device of claim 15 wherein each template is N pixels thick, N being a positive integer value.

21. The device of claim 15 wherein the electronic circuitry is further configured to apply an integer-based motion compensation to identify the first and the second templates respectively in the first and the second reference pictures.

22. The device of claim 15 wherein a motion vector difference is added to at least one of the bi-prediction candidates of the initial list before calculating the score.

23. The device of claim 16 wherein, responsive to the initial list comprising uni-prediction candidates, only the bi-prediction candidates are re-ordered and each uni-prediction candidate keeps a same index in the re-ordered list as in the initial list.

24. The device of claim 15 wherein, responsive to the initial list comprising uni-prediction candidates, uni-prediction candidates of the initial list are transformed into bi-prediction candidates before the calculation of the scores.

25. The device of claim 24 wherein, bi-prediction candidates of a re-ordered list obtained from a uni-prediction candidate of the initial list are used for a prediction of the motion information of the current block.

26. The device of claim 16 wherein, responsive to the initial list comprises uni-prediction candidates, uni-prediction candidates are excluded from the re-ordered list.

27-30. (canceled)
